(19) United States
(12) Patent Application Publication
(10) Pub. No.: US 2026/0069083 A1
(43) Pub. Date: Mar. 12, 2026

(54) COFFEE GRINDER WITH GRIND SIZE EASY TO ADJUST

(71) Applicant: Guangdong Shunde Folkwang Design co., Ltd., Foshan (CN)

(72) Inventors: Hao Xiong, Foshan (CN); Lang Ouyang, Foshan (CN); Zenghua Ling, Foshan (CN)

(21) Appl. No.: 19/208,796

(22) Filed: May 15, 2025

(30) Foreign Application Priority Data
Sep. 11, 2024 (CN) 202422225474.8
Apr. 29, 2025 (CN) 202520853070.5

(51) Int. Cl. A47J 42/18; A47J 42/16; A47J 42/40; A47J 42/50

(52) U.S. Cl. CPC A47J 42/18; A47J 42/16; A47J 42/50; A47J 42/40

(57) ABSTRACT

A coffee grinder with a grind size easy to adjust includes a cup lid, a coffee cup, a bean hopper and a lid body. The cup lid is arranged at the bottom of the coffee cup. The bean hopper is arranged at the top of the coffee cup. The lid body is arranged at the top of the bean hopper. A protruding tool-setting screw rod is arranged on a bottom surface of the lid body. The tool-setting screw rod extends into a driving disc base. A rotary rod is arranged in a tool-setting nut sleeve and has an end extending into a motor arranged in the tool-setting screw rod as well as an end extending into a bean hopper support. The coffee grinder is simple and reasonable in structural design and being provided with a structure for adjusting the size of ground coffee beans.

### CROSS-REFERENCE TO RELATED APPLICATIONS

This application claims priority to Chinese Patent Application No. 202422225474.8, filed on Sep. 11, 2024 and No. 202520853070.5, filed on Apr. 29, 2025, which is hereby incorporated by reference in its entirety.

### TECHNICAL FIELD

The invention belongs to the technical field of coffee grinders, and particularly relates to a coffee grinder with a grind size easy to adjust.

### BACKGROUND OF THE INVENTION

Nowadays, cocoa, coffee and tea are referred to as three main drinks in the present world. Cocoa stimulates excitement, coffee is romantic and aromatic, and tea is natural and fresh. Coffee, as one the three main drinks in the world and a drink with a long history, has been widely known, is being accepted by more and more customers and is gradually associated with fashion, modern life, work, and recreation and entertainment. More and more people like to drink coffee, and no matter whether they are at home, in office or go out for a social contact or a trip, a coffee grinder is indispensable for a cup of coffee brewed from freshly ground coffee beans.

However, when the size of coffee beans ground by coffee grinders in the prior art needs to be adjusted, a coffee cup has to be detached, and then the grind size is adjusted at the bottom of the inside of the coffee grinders, leading to much inconvenience in preparing freshly brewed coffee.

### BRIEF SUMMARY OF THE INVENTION

The invention provides a coffee grinder with a grind size easy to adjust to solve the problems proposed in the description of related art.

The technical solution of the invention is implemented as follows: a coffee grinder with a grind size easy to adjust includes a cup lid, a coffee cup, a bean hopper and a lid body. The cup lid is arranged at a bottom of the coffee cup. The bean hopper is arranged at a top of the coffee cup. The lid body is arranged at a top of the bean hopper.

The cup lid is in snap fit with the coffee cup.

A protruding convex ring is arranged on a top surface of the cup lid, and key grooves are formed in a side of the ring.

Protruding key blocks are arranged on a side of an inside of the coffee cup, and the key blocks extend into the key grooves and are in snap fit with the key grooves.

The key blocks arranged in the coffee cup include upper key blocks and lower key blocks.

The coffee cup is in snap fit with the bean hopper.

A protruding bean hopper base is arranged on a bottom surface of the bean hopper, and a driving disc is arranged on a top surface of the bean hopper.

Key grooves are formed in a side of the bean hopper base, the bean hopper base extends into the coffee cup, and the key grooves are connected to the key blocks arranged in the coffee cup to form a snap fit structure between the bean hopper and the coffee cup.

The key grooves formed in the bean hopper base are shaped like a right-angled U, such that the key grooves formed in the bean hopper base are provided with upper and lower clamping grooves.

A driving disc base is arranged in the driving disc, a protruding elastic bead is arranged on a side of a wall surface of the driving disc base, and a key groove is formed in the other side of the wall surface of the driving disc base.

A bean hopper opening is formed in a side of the bean hopper, a bean hopper door is arranged in the bean hopper, the bean hopper door is movable, and the bean hopper opening is located on a side of the bean hopper door, such that a structure for adding coffee beans is formed.

The lid body is in snap fit with the bean hopper.

A key cover is arranged on a top surface of the lid body, and a protruding tool-setting screw rod is arranged on a bottom surface of the lid body.

The tool-setting screw rod extends into the driving disc base and has an end threadedly assembled on a tool-setting nut sleeve, and tool-setting nut sleeve is inlaid in the tool-setting screw rod.

A rotary rod is arranged in the tool-setting nut sleeve, the rotary rod has an end extending into a motor arranged in the tool-setting screw rod as well as an end extending into a bean hopper support, and a bean hopper support base extends into the bean hopper support.

The bean hopper support base is arranged at a top of a bean hopper support plate, and a spring is arranged between the bean hopper support and the bean hopper support plate.

An upper grinding disc is arranged at a bottom of the bean hopper support base and located at a top of a grinding disc holder, and a lower grinding disc is arranged at a bottom of the grinding disc holder.

As a preferred embodiment, a spring is arranged at a top of the lower grinding disc, and a grinding disc lock is arranged at a bottom of the lower grinding disc.

The grinding disc lock is arranged on a bottom surface of the bean hopper base, a convex ring structure concentric with the grinding disc lock is arranged on a periphery of the grinding disc lock, and the convex ring structure is a splash-proof surrounding edge.

The bean hopper base is cylindrical on the whole, a plurality of groups of key grooves are formed in a circumferential surface of the bean hopper base, the plurality of groups of key grooves are uniformly distributed in an outer circumferential surface of the bean hopper base, and the number of groups of key grooves is 2-5.

Each group of key grooves is shaped like a vertical right-angled U and includes a horizonal first positioning groove, a horizontal second positioning groove and a vertical connecting groove connecting the first positioning groove and the second positioning groove.

As a preferred embodiment, a silicone plug is arranged at a bottom of the key cover, a top inner lid is arranged at a bottom of the silicone plug, a circuit board is arranged at a bottom of the top inner lid, a circuit board base is arranged at a bottom of the circuit board, a battery is arranged at a bottom of the circuit board and located at a top of a battery holder, the motor is arranged at a bottom of the battery holder and extends into a motor base, a sealing ring is arranged on a side of the motor base, a spring is arranged on a side of the motor base, a spring is arranged on a bottom surface of the sealing ring, and an end of the spring is arranged at a top of the tool-setting screw rod.

As a preferred embodiment, a driving lever is arranged on a side, opposite to a battery holder, of a top of the tool-setting screw rod, and a side of the battery holder extends to a top of the tool-setting screw rod.

As a preferred embodiment, a scale is arranged on a side of an outer wall of the lid body.

As a preferred embodiment, a pointer is arranged on a side of an outer wall of the bean hopper.

By adopting the above technical solution, the invention has the following beneficial effects: the structural design is simple and reasonable, and a structure for adjusting the size of ground coffee beans is provided; the coffee grinder includes the cup lid, the coffee cup, the bean hopper and the lid body, the cup lid is arranged at the bottom of the coffee cup, the bean hopper is arranged at the top of the coffee cup, the lid body is arranged at the top of the bean hopper, the protruding tool-setting screw rod is arranged at one end of the lid body, the rotary rod extends into the tool-setting screw rod, the motor drives the rotary rod, the rotary rod drives the lower grinding disc to rotate by means of a transmission part, and the lower grinding disc extends into the upper grinding disc; when coffee beans pass through a gap between the upper grinding disc and the lower grinding disc, the coffee beans will be ground into coffee powder; the scale is arranged on one side of the outer wall of the lid body, the pointer is arranged on one side of the outer wall of the bean hopper, the lid body rotates to realize an adjustment, and when the lid body rotates, the upper grinding disc is driven to rotate; and the width of the gap between the upper grinding disc and the lower grinding disc is adjustable, such that a structure for adjusting the size of ground coffee beans is realized.

### BRIEF DESCRIPTION OF THE SEVERAL VIEWS OF THE DRAWINGS

To better clarify the technical solutions in the embodiments of the invention or the prior art, drawings used for describing the embodiments of the invention or the prior art are briefly introduced below. Obviously, the drawings described below merely illustrate some embodiments of the invention, and those ordinarily skilled in the art may obtain other drawings according to the following ones without creative labor.

FIG. 1 is an overall structural diagram of a coffee grinder according to the invention.

FIG. 2 is an overall structural diagram in a state where a bean hopper door is opened according to the invention.

FIG. 3 is an overall exploded structural view of the coffee grinder according to the invention.

FIG. 4 is an overall structural diagram of a driving disc according to the invention.

FIG. 5 is an overall exploded structural view of a lid body according to the invention.

FIG. 6 is an overall sectional structural view in a state where the lid body and a bean hopper are assembled together according to the invention.

FIG. 7 is an overall structural diagram of the bean hopper according to the invention.

FIG. 8 is an overall structural diagram of the coffee grinder according to the invention.

FIG. 9 is a structural diagram of a bean hopper base of the coffee grinder according to the invention.

### DETAILED DESCRIPTION OF THE INVENTION

The technical solutions in the embodiments of the invention will be clearly and completely described below in conjunction with accompanying drawings of the embodiments of the invention. Obviously, the embodiments described below are merely illustrative ones and are not all possible ones of the invention. All other embodiments obtained by those ordinarily skilled in the art based on the following ones without creative labor should also fall within the protection scope of the invention.

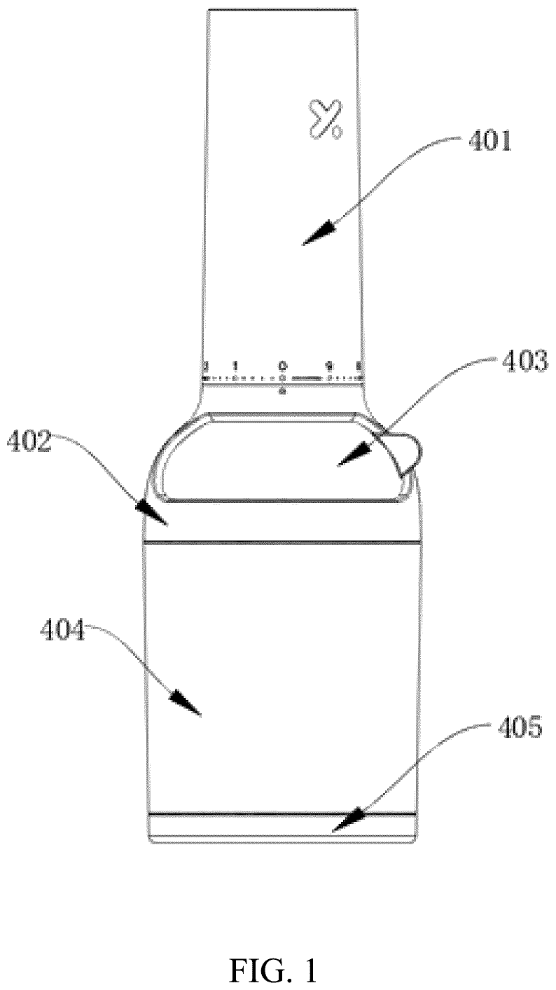

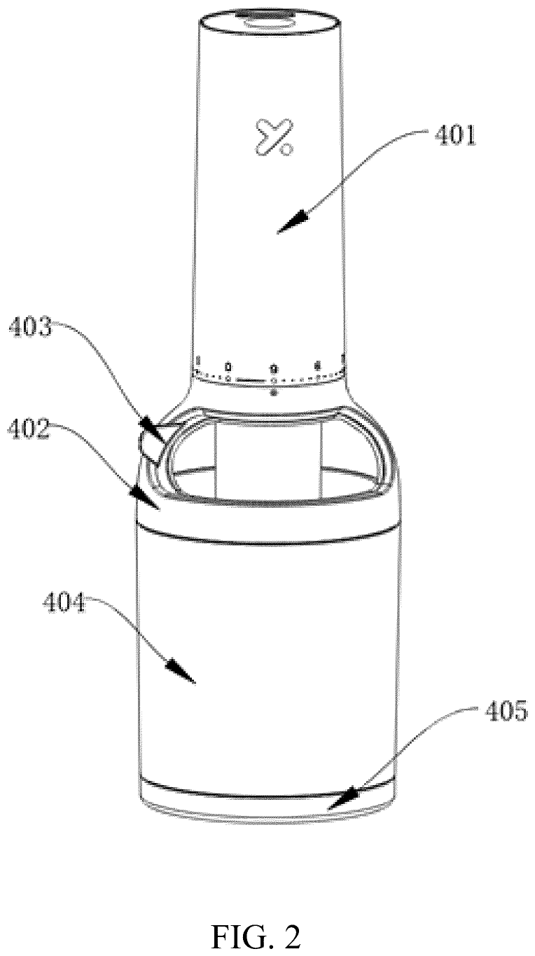

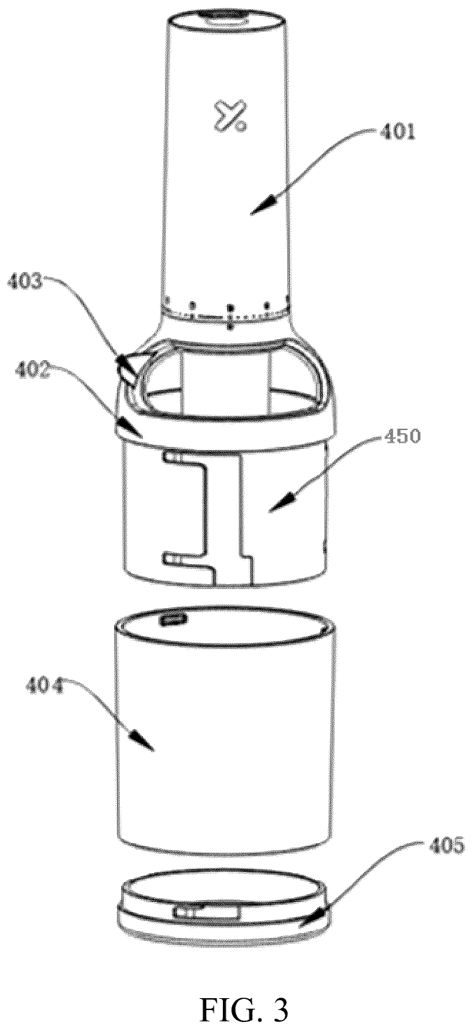

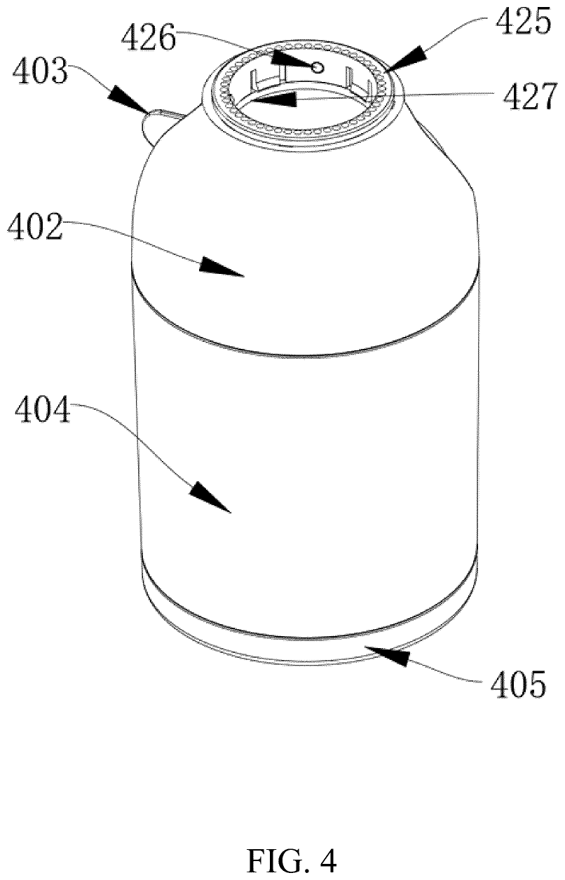

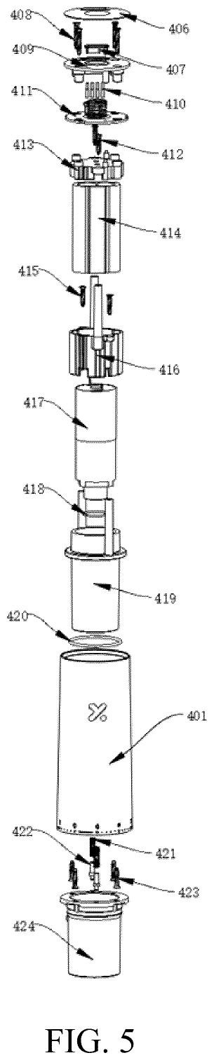

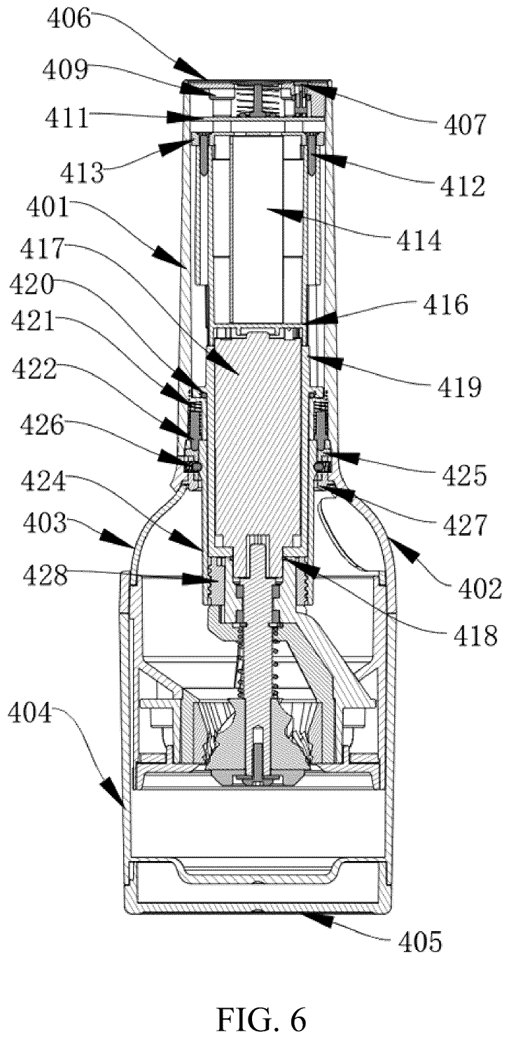

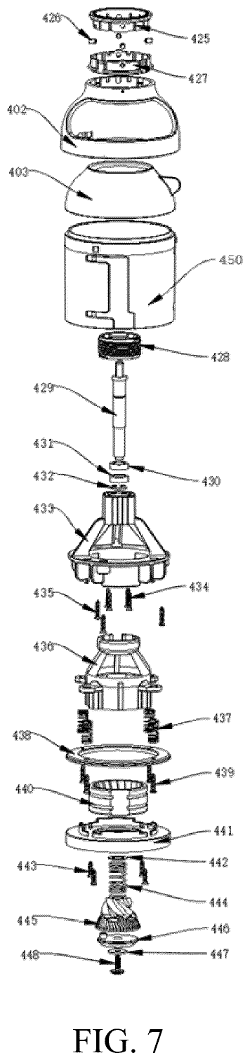

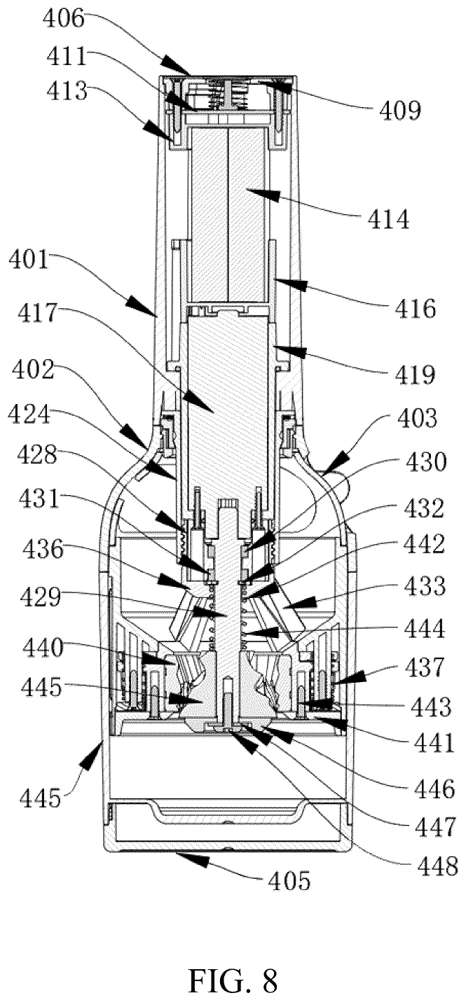

As shown in FIGS. 1-9:

### Embodiment 1

A coffee grinder includes a cup lid 405, a coffee cup 404, a bean hopper 402 and a lid body 401. The cup lid 405 is arranged at the bottom of the coffee cup 404. The bean hopper 402 is arranged at the top of the coffee cup 404. The lid body 401 is arranged at the top of the bean hopper 402. A protruding tool-setting screw rod 424 is arranged at one end of the lid body 401. A rotary rod 429 extends into the tool-setting screw rod 424. A motor 417 drives the rotary rod 429, and the rotary rod 429 drives a lower grinding disc 445 to rotate by means of a transmission part. The lower grinding disc 445 extends into an upper grinding disc 440. When coffee beans pass through a gap between the upper grinding disc 440 and the lower grinding disc 445, the coffee beans will be ground into coffee powder. A scale is arranged on one side of an outer wall of the lid body 401. A pointer is arranged on one side of an outer wall of the bean hopper 402. The lid body 401 rotates to realize an adjustment. When the lid body 401 rotates, the upper grinding disc 440 is driven to rotate, and the width of the gap between the upper grinding disc 440 and the lower grinding disc 445 is adjustable, such that a structure for adjusting the size of ground coffee beans is realized.

A key cover 406 is arranged on a top surface of the lid body 401. The protruding tool-setting screw rod 424 is arranged on a bottom surface of the lid body 401 and extends into a driving disc base 427. One end of the tool-setting screw rod 424 is threadedly assembled on a tool-setting nut sleeve 428. The tool-setting nut sleeve 428 is inlaid in the tool-setting screw rod 424. The rotary rod 429 is arranged in the tool-setting nut sleeve 428. One end of the rotary rod 429 extends into the motor 417 arranged in the tool-setting screw rod 424, and the other end of the rotary rod 429 is arranged in a bean hopper support 433. A bean hopper support base 436 extends into the bean hopper support 433. The bean hopper support base 436 is arranged at the top of a bean hopper support plate 438. The upper grinding disc 440 is arranged at the bottom of the bean hopper support base 436 and located at the top of a grinding disc holder 441, and the lower grinding disc 445 is arranged at the bottom of the grinding disc holder 441. The driving disc base 427 is arranged in the driving disc 425. A protruding elastic bead 426 is arranged on one side of a wall surface of the driving disc base 427 and clamped in an elastic bead ring-groove of the tool-setting screw rod 424 by means of an elastic force. In this way, the lid body 401 is able to rotate clockwise or anticlockwise by 324°. Every time the lid body 401 rotates by 7.2°, a position allowing the lid body 401 to stay therein is formed, and 45 positions allowing the lid body 401 to stay therein are formed in total, such that a structure for adjusting the size of ground coffee beans is realized.

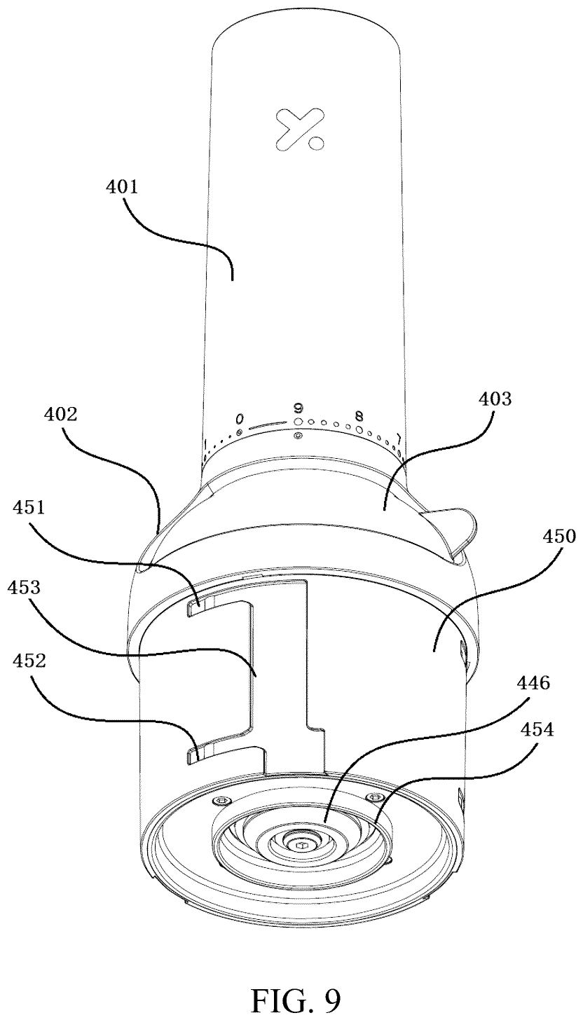

When a FIG. 9 of the scale of the lid body 401 faces the dot pointer arranged on the bean hopper 402, the scale is adjusted to a coarsest bean grinding state. When the lid body 401 is clockwise rotated by 324°, a figure 0 of the scale of the lid body 401 faces the dot pointer arranged on the bean hopper 402, and at this moment, the scale is adjusted to a finest bean grinding state.

The cup lid 405 is in snap fit with the coffee cup 404. A protruding ring is arranged on a top surface of the cup lid 405, key grooves are formed in one side of the ring, protruding key blocks are arranged on one side of the inside of the coffee cup 404 and extend into the key grooves, such that a snap fit structure is formed. When the coffee bean grinding process is completed, ground coffee powder is received in the coffee cup 404, the coffee cup 404 is detached from the coffee grinder, and the cup lid 405 originally clamped and stored at the bottom of the coffee cup 404 is detached from the bottom of the coffee cup 404, directly covers the coffee cup 404 and is tightened, such that the coffee cup 404 may be carried easily and the coffee powder will not spill out of the coffee cup 404.

The coffee cup 404 is in the form of a complete cup on the whole, and the cup lid 405 is designed to cover the coffee cup 404. When the coffee cup 404 needs to be assembled on the coffee grinder to receive ground coffee powder, the cup lid 405 is clamped at the bottom of the coffee cup 404 to be stored and prevented from being lost.

The key blocks arranged in the coffee cup 404 include upper key blocks and lower key blocks. The lower key blocks in the coffee cup 404 are in snap fit with the cup lid 405. The upper key blocks in the coffee cup 404 are in snap fit with the bean hopper 402.

A protruding bean hopper base 450 is arranged on a bottom surface of the bean hopper 402 and extends into the coffee cup 404. The bean hopper base 450 is cylindrical on the whole, and a plurality of groups of key grooves are formed in a circumferential surface of the bean hopper base 450 and uniformly distributed in an outer circumferential surface of the bean hopper base 450. The key grooves are connected to the key blocks arranged in the coffee cup 404, such that a snap fit structure between the bean hopper 402 and the coffee cup 404 is formed. Each group of key grooves in the bean hopper base 450 is shaped like a vertical right-angled U and includes a horizontal first positioning groove 451, a horizontal second positioning groove 452 and a vertical connecting groove 453 connecting the first positioning groove 451 and the second positioning groove 452, wherein the first positioning groove 451 is located above the second positioning groove 452. When the whole bean hopper base 450 extends into the coffee cup 404, the key blocks arranged in the coffee cup 404 are connected and clamped in the first positioning grooves formed in the bean hooper base 450, and at this moment, the coffee powder receiving capacity of the coffee cup 404 is minimized. When the key blocks on the coffee cup 404 slide out of the first positioning grooves 451 in the bean hopper base 450 and slide along the connecting grooves 453, that is, when the bean hopper base 450 is pulled out in a direction away from the coffee cup until the key blocks arranged in the coffee cup 404 are connected and clamped in the second positioning grooves formed in the bean hopper base 450, the coffee powder receiving capacity of the coffee cup 404 is maximized.

No matter whether the key blocks on the coffee cup 404 are clamped in the first positioning grooves 451 or the second positioning grooves 452 of the key grooves in the bean hopper base 450, stable and tight assembly of the coffee grinder will be maintained, and the coffee grinder may be started normally to grind coffee beans in two different states.

The lid body 401 extends into the driving disc 425 arranged on a top surface of the bean hopper 402 by means of the tool-setting screw rod 424, the driving disc 425 is fastened on key blocks of the tool-setting screw rod 424 by means of key grooves, and the lid body 401 is in snap fit with the bean hopper 402.

A silicone plug 407 is arranged at the bottom of the key cover 406. The bottom of the silicone plug 407 is arranged at the top of a top inner lid 409. A circuit board 411 is arranged at the bottom of the top inner lid 409. The bottom of the circuit board 411 is arranged on a circuit board base 413. A battery 414 is arranged at the bottom of the circuit board base 413 and located at the top of a battery holder 416. The motor 417 is arranged at the bottom of the battery holder 416 and extends into a motor base 419. A sealing ring 420 is arranged on one side of the motor base 419. A spring 421 is arranged on a bottom surface of the sealing ring 420, and one end of the spring 421 is arranged at the top of the tool-setting screw rod 424. When a power switch is turned on, the motor 417 rotates to drive the rotary rod 429, the rotary rod 429 drives the lower grinding disc 445 to rotate by means of a transmission part, and coffee beans are ground into coffee powder when passing through the gap between the upper grinding disc 440 and the lower grinding disc 445.

A bean hopper opening is formed in one side of the bean hopper 402, a bean hopper door 403 is arranged in the bean hopper 402 and is movable, and the bean hopper 402 opening is located on one side of the bean hopper door 403, such that a structure for adding coffee beans is formed. The bean hopper door 403 is opened to place coffee beans into the bean hopper 402, then the bean hopper door 403 is closed, and a bean-grinding button switch at the top of the lid body 401 is turned on to grind the coffee beans.

### Embodiment 2

Key blocks arranged on one side of the tool-setting screw rod 424 are connected to key grooves formed in the other side of a wall surface of the driving disc 427, such that a snap fit structure between the lid body 401 and the bean hopper 402 is formed.

### Embodiment 3

Springs 437 are arranged between the bean hopper support 433 and the bean hopper support plate 438. The bean hopper support 433 is locked on the bean hopper base 450 by means of screws 434 and is a non-rotatable part. The bean hopper base 450 is clamped on the bean hopper 402 and is a non-rotatable part. The bean hopper support plate 438 is locked on the bean hopper support 433 by means of screws 439 and is a non-rotatable part. The bean hopper support plate 438 supports the springs 437 to generate an upward elastic force. The lower grinding disc 445 is locked and clamped on the rotary rod 429 by means of a grinding disc lock 446, a screw washer 447 and a screw 448, and when driven by the motor 417, the lower grinding disc 445 only rotates and does not move upwards and downwards. The lower grinding disc 445 supports a spring 444 to generate an upward elastic force.

When the tool-setting nut sleeve 428 moves upwards, the springs 437 and the spring 444 generate an upward elastic force to push the bean hopper support base 436, the upper grinding disc 440, the grinding disc holder 441, the screw washer 442 and screws 443 to return upwards.

### Embodiment 4

A spring 444 is arranged at the top of the lower grinding disc 445, and a grinding disc lock 446 is arranged at the bottom of the lower grinding disc 445. The bean hopper support 433 is locked on the bean hopper base 450 by means of screws 434 and is a non-rotatable part. The bean hopper base 450 is clamped on the bean hopper 402 and is a non-rotatable part. The bean hopper support plate 438 is locked on the bean hopper support 433 by means of screws 439 and is a non-rotatable part. The bean hopper support plate 438 supports springs 437 to generate an upward elastic force. The lower grinding disc 445 is locked and clamped on the rotary rod 429 by means of the grinding disc lock 446, a screw washer 447 and a screw 448, and when driven by the motor 417, the lower grinding disc 445 only rotates and does not move upwards and downwards. The lower grinding disc 445 supports the spring 444 to generate an upward elastic force.

When the tool-setting nut sleeve 428 moves upwards, the springs 437 and the spring 444 generate an upward elastic force to push the bean hopper support base 436, the upper grinding disc 440, the grinding disc holder 441, the screw washer 442 and screws 443 to return upwards.

### Embodiment 5

An assembly of the lid body 401 includes the following accessories: a key cover 406, a silicone plug 407, screws 408, a top inner lid 409, lamp posts 410, a circuit board 411, screws 412, a circuit board base 413, a battery 414, screws 415, a battery holder 416, a motor 417, a sealing ring 418, a motor base 419, a sealing ring 420, a lid body 401, a spring 421, a driving lever 422, screws 423 and a tool-setting screw rod 424.

An assembly of the bean hopper 402 includes the following accessories: a driving disc 425, an elastic bead 426, a driving disc base 427, a bean hopper 402, a bean hopper door 403, a bean hopper base 450, a tool-setting nut sleeve 428, a rotary rod 429, a bearing 430, a bearing 431, a clamp ring 432, a bean hopper support 433, screws 434, screws 435, a bean hopper support base 436, springs 437, a bean hopper support plate 438, screws 439, an upper grinding disc 440, a grinding disc holder 441, a screw washer 442, screws 443, a spring 444, a lower grinding disc 445, a grinding disc lock 446, a screw washer 447 and a screw 448.

### Embodiment 6

A driving lever 422 is arranged on a side, opposite to the battery holder 416, of the top of the tool-setting screw rod 424. One side of the battery holder 416 extends into the top of the tool-setting screw rod 424. When an internal structure of a grind size adjusting mechanism of the assembly of the lid body 401 works, only the lid body 401, the spring 421, the driving lever 422, the screw 423 and the tool-setting screw rod 424 rotate within 0-324°, powder is transmitted by means of the tool-setting screw rod 424 to drive the tool-setting nut sleeve 428 to rotate clockwise or anticlockwise, and when rotating clockwise or anticlockwise, the tool-setting nut sleeve 428 moves upwards or downwards at the same time to drive the bean hopper support base 436, the upper grinding disc 440, the grinding disc holder 441, the screw washer 442 and screws 443 in the assembly of the bean hopper 402 to move upwards or downwards at the same time; when the tool-setting nut sleeve 428 moves upwards in place, the grind size adjusting mechanism is adjusted to the coarsest bean grinding state; and when the tool-setting nut sleeve 428 moves downwards in place, the grind size adjusting mechanism is adjusted to the finest bean grinding state.

### Embodiment 7

Referring to FIG. 9 which illustrates the structure of the bean hopper base 450, a convex ring structure concentric with the grinding disc lock 446 is arranged on a bottom surface of the bean hopper base 450 and located on the periphery of the grinding disc lock 446, the convex ring structure is a splash-proof surrounding edge 454 for preventing ground coffee powder from splashing out and blocking the ground coffee powder. Because coffee powder ground by the grinding discs has a centrifugal rotation speed in the grinding process of the grinding discs and has certain potential energy to splash out, such a surrounding edge is arranged to block most coffee powder and prevent the coffee powder from splashing onto the circumferential wall, such that the coffee powder may better fall into the coffee cup 404.

The embodiments described above are merely preferred ones of the invention and are not used to limit the invention. Any modifications, equivalent substitutions and improvements made based on the spirit and principle of the invention should also fall within the protection scope of the invention.

What is claimed is:

1. A coffee grinder with a grind size easy to adjust, comprising a cup lid, a coffee cup, a bean hopper and a lid body, the cup lid being arranged at a bottom of the coffee cup, the bean hopper being arranged at a top of the coffee cup, and the lid body being arranged at a top of the bean hopper, wherein:
the cup lid is in snap fit with the coffee cup;
the coffee cup is in snap fit with the bean hopper;
a protruding bean hopper base is arranged on a bottom surface of the bean hopper, and the bean hopper base extends into the coffee cup;
a driving disc is arranged on a top surface of the bean hopper base, a driving disc base is arranged in the driving disc, and a protruding elastic bead is arranged on a side of a wall surface of the driving disc base;
a bean hopper opening is formed in a side of the bean hopper, and a bean hopper door is arranged in the bean hopper;
the lid body is in snap fit with the bean hopper;
a key cover is arranged on a top surface of the lid body, and a protruding tool-setting screw rod is arranged on a bottom surface of the lid body;
the tool-setting screw rod extends into the driving disc base and has an end threadedly assembled on a tool-setting nut sleeve;
a rotary rod is arranged in the tool-setting nut sleeve, and the rotary rod has an end extending into a motor arranged in the tool-setting screw rod as well as an end extending into a bean hopper support;
a bean hopper support base extends into the bean hopper support and is arranged at a top of a bean hopper support plate, an upper grinding disc is arranged at a bottom of the bean hopper support base and located at a top of a grinding disc holder, and a lower grinding disc is arranged at a bottom of the grinding disc holder.

2. The coffee grinder with a grind size easy to adjust according to claim 1, wherein a spring is arranged at a top of the lower grinding disc, and a grinding disc lock is arranged at a bottom of the lower grinding disc.

3. The coffee grinder with a grind size easy to adjust according to claim 2, wherein the grinding disc lock is arranged on a bottom surface of the bean hopper base, a convex ring structure concentric with the grinding disc lock is arranged on a periphery of the grinding disc lock, and the convex ring structure is a splash-proof surrounding edge.

4. The coffee grinder with a grind size easy to adjust according to claim 3, wherein the bean hopper base is cylindrical on the whole, a plurality of groups of key grooves are formed in a circumferential surface of the bean hopper base, the plurality of groups of key grooves are uniformly distributed in an outer circumferential surface of the bean hopper base, and the number of groups of key grooves is 2-5.

5. The coffee grinder with a grind size easy to adjust according to claim 3, wherein each group of key grooves is shaped like a vertical right-angled U and comprises a horizonal first positioning groove, a horizontal second positioning groove and a vertical connecting groove connecting the first positioning groove and the second positioning groove.

6. The coffee grinder with a grind size easy to adjust according to claim 2, wherein a silicone plug is arranged at a bottom of the key cover, a top inner lid is arranged at a bottom of the silicone plug, a circuit board is arranged at a bottom of the top inner lid, a circuit board base is arranged at a bottom of the circuit board, a battery is arranged at a bottom of the circuit board and located at a top of a battery holder, the motor is arranged at a bottom of the battery holder and extends into a motor base, a sealing ring is arranged on a side of the motor base, a spring is arranged on a side of the motor base, a spring is arranged on a bottom surface of the sealing ring, and an end of the spring is arranged at a top of the tool-setting screw rod.

7. The coffee grinder with a grind size easy to adjust according to claim 3, wherein a driving lever is arranged on a side, opposite to a battery holder, of a top of the tool-setting screw rod, and a side of the battery holder extends to a top of the tool-setting screw rod.

8. The coffee grinder with a grind size easy to adjust according to claim 4, wherein a scale is arranged on a side of an outer wall of the lid body.

9. The coffee grinder with a grind size easy to adjust according to claim 5, wherein a pointer is arranged on a side of an outer wall of the bean hopper.
